(19) United States
(12) Patent Application Publication
(10) Pub. No.: US 2010/0159218 A1
(43) Pub. Date: Jun. 24, 2010

(54) TRANSFER PAPER HAVING UV OFFSET PRINT LAYER AND UV REINFORCING LAYER AND METHOD FOR MANUFACTURING THE SAME

(76) Inventor: HyoSang Yum, Seoul (KR)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/340,203

(22) Filed: Dec. 19, 2008

(51) Int. Cl. B32B 3/10; B05D 5/10

(52) U.S. Cl. 428/201; 427/207.1

(57) ABSTRACT

Transfer paper comprising a sheet-shaped base material and a transfer layer. The transfer layer is composed of a release layer comprising transparent silicon, a primary coating layer to be coated on a top face of the release layer in conformity with contours of a design composed of a prescribed pattern or photograph, a secondary coating layer to be coated on a top face of the primary coating layer, a UV offset print layer to be coated on a top face of the secondary coating layer by nozzle injection of a UV offset ink, a protective layer to be coated on a top face of the UV offset print layer, a first masking layer to be coated on a top face of the protective layer, and an adhesive layer to be coated on a top face of the first masking layer.

### FIELD OF THE INVENTION

The present invention relates to transfer paper having a UV (ultraviolet) offset print layer and a UV reinforcing layer for interposing the UV offset print layer therein and protecting it and to a method for manufacturing the same.

### BACKGROUND OF THE INVENTION

The transfer paper as referred to herein is one in which a transfer layer is laminated on one face of a sheet-shaped base material in a freely transferable manner. This transfer layer is formed as a whole in such a manner that while centering a print layer formed by printing a design of any sort such as a pattern or a photograph, in addition to this print layer, a release layer or plural protective layers are laminated so as to interpose the print layer therein.

In this transfer paper, the foregoing transfer layer is transferred onto a material to be transferred which is made of a raw material of any sort including fibers, potteries, ceramics, woods and metallic plates (such a material will be hereinafter simply be referred to as “material to be transferred”) by heat, water, pressure or other release means, and after the transfer, the sheet-shaped base material of the transfer paper is peeled off and removed from the transfer layer.

Here, as a method for forming the foregoing transfer layer on one face of the sheet-shaped material, a coating method generally utilizes a nozzle and/or utilizes a silk screen plate of from about 30 to 40 mesh. The term “mesh” as referred to herein means the number of eyes per square inch of a sieve; and the larger the numerical number, the more minute the printing. That is, the transfer layer is formed by laminating plural raw material layers. Therefore, depending upon the viscosity characteristics of the raw material of the respective layer; in the case of a raw material with low viscosity, a nozzle coating method which is excellent in uniformity of coating and precision is desirable. On the other hand, in the case of a raw material with high viscosity, injection utilizing a nozzle is impossible because plugging of the nozzle is caused. Accordingly, in the latter case, a coating method utilizing a screen plate is carried out instead of adopting the nozzle coating method.

In the transfer layer which is transferred onto the material to be transferred utilizing transfer paper having such characteristics, it is expected that effects which the transfer layer should exhibit are thoroughly maintained during a period of time when the material to be transferred is used under a severe environment.

Actually, when the material to be transferred is exposed to various unfavorable conditions, the transfer layer will be also exposed to similarly unfavorable conditions. As a result, there has frequently been a problem that a physical change such as deterioration or peeling of the transfer layer is caused so that the transfer layer is deformed from the state that it should originally exist, and the transfer layer cannot function.

In particular, in the case where the transfer layer is utilized for clothing (for example, T-shirts) or footgear (for example, sports shoes) to which the transfer paper is most likely 30 applied, the transfer layer is transferred onto a top face of the fiber fabric. Accordingly, there may be a possibility that the transfer paper is placed under complex and unfavorable conditions. For example, the base fiber fabric may expand and contract. During washing, the transfer layer may come into contact with a detergent. During outdoor activity of a user, the transfer layer may be irradiated by sunlight.

JP-A-8-207499 or JP-A-2003-231393 disclose transfer paper which aims to keep these properties over a long period of time.

### SUMMARY OF THE INVENTION

An object of the invention is to provide transfer paper in which not only PET can be used as a sheet-shaped base material, but even when a transfer layer is placed under various unfavorable conditions as described previously, properties of a transfer layer can be kept over a long period of time. It is also an object of the invention to provide a method for10 manufacturing the same.

Specifically, the invention provides the following:

(1) Transfer paper comprising a sheet-shaped base material and a transfer layer laminated and formed on the surface of the sheet-shaped base material, wherein the transfer layer is one formed by successively laminating respective layers of a release layer comprising transparent silicone, a primary coating layer comprising one-pack polyurethane to be coated on a top face of the release layer in conformity with contours of a design composed of a prescribed pattern or photograph, a secondary coating layer comprising a two-pack polyurethane to be coated on a top face of the primary coating layer, a UV offset print layer to be coated on a top face of the secondary coating layer by nozzle injection of a UV offset ink, a protective layer comprising a one-pack polyurethane to be coated on a top face of the UV offset print layer, a first masking layer comprising a white polyurethane to be coated on a top face of the protective layer, and an adhesive layer comprising a one-pack adhesive to be coated on a top face of the first masking layer.

(2) The transfer paper as set forth above in (1), wherein there is further formed a second masking layer comprising a one-pack polyurethane and carbon to be coated on a top face of the first masking layer.

(3) A method for manufacturing transfer paper having a UV offset print layer and a UV 35 reinforcing layer, which comprises the successive steps of forming a release layer comprising transparent silicone on a top face of a sheet-shaped base material composed of PET, forming a primary coating layer comprising a one-pack polyurethane to be coated on a top face of the release layer in conformity with contours of a design composed of a prescribed pattern or photograph; forming a secondary coating layer comprising a two-pack polyurethane to be coated on a top face of the primary coating layer, coating a UV offset print layer to be coated on a top face of the secondary coating layer by nozzle injection of a UV offset ink, forming a protective layer comprising a one-pack polyurethane to be coated on a top face of the UV offset print layer, forming a first masking layer comprising a white polyurethane to be coated on a top face of the protective layer, and forming an adhesive layer comprising a one-pack adhesive to be coated on a top face of the first masking layer.

(4) The method for manufacturing transfer paper having a UV offset print layer and a UV 15 reinforcing layer as set forth above in (3), which further comprises forming a second masking layer comprising a one-pack polyurethane and carbon to be coated on a top face of the first masking layer.

As is clear from the foregoing description, the invention brings effects as enumerated below:

(a) It becomes possible to use, as a base material for transfer paper, PET (polyethylene terephthalate) which has been considered to be difficult for use in existing transfer papers. For this reason, it becomes possible to perform UV offset printing using a UV offset ink, and minute and beautiful printing can be achieved, resulting in excellent workmanship.

(b) The transfer layer can be provided in a state in which the UV offset layer is protected y the UV reinforcing layer. Therefore, there is provided a transfer paper which is excellent in tensile strength and excellent in heat resistance, light fastness and weather resistance.

(c) According to the foregoing, it becomes possible to obtain transfer paper in which even if receiving external stimulation, the transfer layer is not readily damaged and a semi-permanent working life is guaranteed.

### BRIEF DESCRIPTION OF THE DRAWING

FIG. 1 is an enlarged longitudinal cross-sectional view of transfer paper according to the

### DESCRIPTION OF THE PREFERRED EMBODIMENTS

The invention is hereunder described in detail with reference to a best mode for carrying out an invention as shown in the drawing.

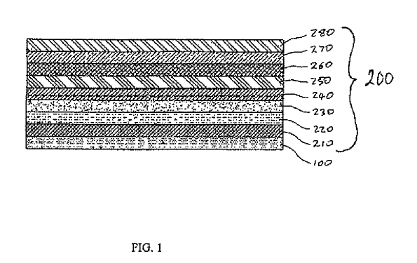

FIG. 1 is an enlarged longitudinal cross-sectional view of transfer paper according to the invention. PET (polyethylene terephthalate) is used as a sheet-shaped base material 100, and a transfer layer 200 is laminated and formed on a top face of this sheet-shaped base material 100.

The sheet-shaped base material 100 can be made of a PET material. A product having been subjected to an antistatic treatment is favorable (an antistatic treatment by passing a current with high frequency is generally used). For example, a product manufactured by SKC Co., Ltd., Korea can be used.

The transfer layer 200 of the invention is formed by applying or coating a substance composed of various materials on a number of layers and laminating it. Specifically, this transfer layer 200 is configured of a release layer 210, a primary coating layer 220, a secondary coating layer 230, a UV offset print layer 240, a protective layer 250, a first masking layer 260, a second masking layer 270 and an adhesive layer 280.

In order to configure this transfer layer 200, the release layer 210 to be formed on a top face of the sheet-shaped base material 100 is formed by coating a mixed chemical of silicone and a rubber based raw material (for example, a mixture of silicone rubber and a wax in a ratio of 71211) in a thickness of from 1.5 to 2 pm on the top face of the sheet-shaped base material 100 by utilizing a machine which is called a comma coating device; and after coating the foregoing mixed chemical, the coated mixed chemical is dried for from about 3 to 5 minutes under a hot air atmosphere at from 145 to 1600 C, whereby it is fixed to and formed on the top face of the sheet-shaped base material 100.

Transfer paper comprising a sheet-shaped base material and a transfer layer. The transfer layer is composed of a release layer comprising transparent silicon, a primary coating layer to be coated on a top face of the release layer in conformity with contours of a design composed of a prescribed pattern or photograph, a secondary coating layer to be coated on a top face of the primary coating layer, a UV offset print layer to be coated on a top face of the secondary coating layer by nozzle injection of a UV offset ink, a protective layer to be coated on a top face of the UV offset print layer, a first masking layer to be coated on a top face of the protective layer, and an adhesive layer to be coated on a top face of the first masking layer.

Next, the primary coating layer 220 is coated on a top face of the foregoing release layer 210 such that it is adaptive with a design composed of a prescribed pattern or photograph to be formed on the UV offset print layer 240 as described later in conformity with contours thereof.

That is, the primary coating layer 220 is formed by mixing 100 parts by weight of polymeric glycol which is a one-pack polyurethane (soft segment polyurethane) and from 230 to 250 parts by weight of an organic polymer aerosol for quenching in a powder form, coating the mixture by means of silk screen printing utilizing a 300-mesh silk screen unit and then subjecting to natural drying or blast drying under a temperature atmosphere at from 20° to 40° C.

In a process of forming the UV offset print layer as described later, the primary coating layer 220 enhances flexibility and degree of color development of the surface of the UV offset print layer.

Furthermore, the secondary coating layer 230 is formed by coating on a top face of the foregoing primary coating layer 220 while using a two-pack polyurethane as a raw material.

That is, the secondary coating layer 230 is formed by mixing 100 parts by weight of a chain extender as a two-pack polyurethane (hard segment polyurethane) and from 20 to 30 parts by weight of a mixture of an organic polymer aerosol for quenching in a powder form and silicone and subjecting the mixture to silk screen printing in a state in which air bubbles have been removed.

This secondary coating layer 230 has an action to enhance abrasion strength and UV printing properties on the surface of the UV offset print layer by using a two-pack polyurethane of a hardener type.

Subsequently, the UV offset print layer 240 is formed by printing a UV ink on a top 30 face of the hardened secondary coating layer 230. A print face thereof is positioned in the centre of the transfer layer, and a design composed of a prescribed pattern or photograph of the transfer layer is formed thereon.

In forming this UV offset print layer 240, ink having light fastness, heat resistance and weather resistance can be used such that color deformation of physical property deformation by light or heat is not generated.

Also, the protective layer 250 to be formed on a top face of the UV offset print layer 240 is formed in such a manner that after the foregoing UV offset print layer 240 has been completely hardened, polymeric glycol as a one-pack polyurethane is printed on a top face of the UF offset print layer 240 by means of silk screen printing so as to cover the design pattern formed on the UV offset print layer 240.

In order that the protective layer 250 may play a role to reinforcing the peel properties and stretching properties of the UV ink, it can be formed by natural drying or blast drying under a temperature atmosphere of from 20° to 40° C.

Next, the first masking layer 260 is formed by coating a one-pack white polyurethane ink on a top face of the foregoing protective layer 250 by means of silk screen printing.

Similar to the case of the protective layer 250, the first masking layer 260 is formed by natural drying or blast drying under a temperature atmosphere of from 20 to 40° C.

Here, it is possible to further form the second masking layer 270 by coating, as raw20 materials, a polymeric glycol of a one-pack polyurethane and carbon on a top face of the foregoing first masking layer 260.

By printing and forming a mixture of polymeric glycol as a one-pack polyurethane and carbon in a weight ratio of 713 or 614 by means of silk screen printing and selectively 25 adopting it depending upon the color of a textile as the material to be transferred, fading of the color of the transfer layer 200 or dropping of the ink is prevented from occurring.

Furthermore, the adhesive layer 280 is formed by coating a one-pack adhesive as a raw material on a top face of the first masking layer 260 or the second masking layer 270 to be selectively adopted. A thermoplastic adhesive and a thermosetting adhesive can be selectively adopted.

The thermoplastic adhesive can be an adhesive made of a vinyl based polymer (for example, polyvinyl acetate may be the foregoing one-pack adhesive) or a copolymer thereof. A blend prepared by adding about 10 parts by weight of the adhesive may be coated by means of silk screen printing.

At that time, the mesh number of a silk screen is determined depending upon the extent to which the pulverization level of the hot melt can be made fine. When a hot melt having a unit of from 0 to 80 pm is used, a silk screen of about 120 meshes is in the most stable state.

As to the drying system of the adhesive layer 280, the adhesive layer 280 is subjected to natural drying or blast drying at from ambient temperature to 40° C. As to the thermosetting adhesive, urea and formalin are heated at from 60 to 90° C. in the presence 01 an alkaline catalyst; a resin of an initial condensate aqueous solution thus obtained is powdered; and at the time of use, a hardener (acidic compound) is added to the aqueous solution, and the mixture is coated, whereby an acidic condensation reaction occurs. The resulting resin is thus hardened and becomes a non-melting resin.

As to the operation system, coating is carried out in a printing system by means of silk screen printing. Though it is desirable to use a silk screen of from 150 to 200 meshes, when the hot melt has a particle size of from 20 to 80 pm, it is desirable to use a silk screen of 20 about 120 meshes.

As to drying, after coating, the surface is subjected to pseudo hardening by means of hot blast drying for about 3 minutes under an atmosphere of from 60 to 70° C. The thermosetting adhesive is used while regulating a blending ratio of the hot melt depending upon the material to be transferred. Different from the thermoplastic adhesive, the thermosetting resin is used such that the amount of the hot melt does not exceed 7 parts by weight.

There is thus accomplished the formation of transfer paper. In the case where this transfer paper is transferred onto clothing or footgear, high stretching properties and bending 30 properties are observed. For that reason, since the majority of other layers for protecting the UV offset print layer 240 are made of a polyurethane raw material, external stimulation due to frequent washing or others of the same degree can be effectively avoided. Thus, the life of the transfer layer 200 semi-permanently increases without readily damaging the UV offset print layer 240.

The invention is applicable to all of the industrial fields utilizing transfer paper.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. Transfer paper comprising:
a sheet-shaped base material comprising PET and a transfer layer laminated and formed on the surface of the sheet-shaped base material, wherein the transfer layer is one formed by successively laminating respective layers of:
a release layer comprising transparent silicone;
a primary coating layer comprising a one-pack polyurethane coated on a top face of the release layer in conformity with contours of a design composed of a prescribed pattern or photograph;
a secondary coating layer comprising a two-pack polyurethane coated on a top face of the primary coating layer;
a UV offset print layer coated on a top face of the secondary coating layer by nozzle injection of a UV offset ink;
a protective layer comprising a one-pack polyurethane coated on a top by face of the UV offset print layer;
a first masking layer comprising a white polyurethane coated on a top face of the protective layer; and
an adhesive layer comprising a one-pack adhesive coated on a top face of the first masking layer.

2. The transfer paper according to claim 1, wherein a second masking layer comprising a one-pack polyurethane and carbon is coated on a top face of the first masking layer.

3. A method for manufacturing transfer paper having a UV offset print layer and a UV reinforcing layer, which comprises the successive steps of:
forming a release layer comprising transparent silicone on a top face of a sheet-shaped base material composed of PET;
forming a primary coating layer comprising a one-pack polyurethane as a coating on a top face of the release layer in conformity with contours of a design composed of a prescribed pattern or photograph;
forming a secondary coating layer comprising a two-pack polyurethane as a coating on a top face of the primary coating layer;
coating a UV offset print layer as a coating on a top face of the secondary coating layer by nozzle injection of a UV offset ink;
forming a protective layer comprising a one-pack polyurethane as a coating on a top face of the UV offset print layer;
forming a first masking layer comprising a white polyurethane as a coating on a top face of the protective layer; and
forming an adhesive layer comprising a one-pack adhesive as a coating on a top face of the first masking layer.

4. The method for manufacturing transfer paper having a UV offset print layer and a UV reinforcing layer according to claim 3, which further comprises forming a second masking layer comprising a one-pack polyurethane and carbon as a coating on a top face of the first masking layer.
